(19) United States
(12) Patent Application Publication
(10) Pub. No.: US 2017/0183149 A1
(43) Pub. Date: Jun. 29, 2017

(54) Garbage Lock

(71) Applicants: Carlos Aponte, Lincoln Park, NJ (US); Luis Aponte, New York, NY (US)

(72) Inventors: Carlos Aponte, Lincoln Park, NJ (US); Luis Aponte, New York, NY (US)

(21) Appl. No.: 14/945,596

(22) Filed: Nov. 19, 2015

(51) Int. Cl. B65F 1/14; B65F 1/16; B65F 1/12

(52) U.S. Cl. CPC B65F 1/141; B65F 1/12; B65F 1/1473; B65F 1/16; B65F 2001/1669

(57) ABSTRACT

Locked Garbage Can—is a held firmly in place garbage can that prevents spills, haphazard to public, improving hygiene as well as esthetics.

The solution consists of a magnetic attached to the garbage can to pair with metallic base, which holds the garbage can firmly in place, while providing an easy way to empty its content.

All across America and around the world garbage can posed a multi issue challenge; garbage spills, haphazard to public, hygiene issues, esthetics and many others problems . . .

“Locked Garbage Can” aims to solve all the issues by an innovation solution that held firmly in place the garbage can.

### CROSS-REFERENCE TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

This invention consists of:
a. A magnet attached to any Garbage Can
b. An iron base

This duo holds the Garbage Can firmly in place, while providing an easy way to empty its content.

### BRIEF SUMMARY OF THE INVENTION

Need: In many occasions, while the garbage rollout cart is unattended before and after the garbage collection times, haphazard incidents occur: From unwanted spills to vehicular accidents, because the garbage can had blown into the street.

A clear example was the September 2012 pile-up in South Carolina due to a trash can. Apparently, a trash can was to blame for a serious four-vehicle accident on I-26. The collision injured two people, according to the police report, the accident occurred when a car stopped on the bridge to avoid hitting a trash can that was left in the roadway.

The method and the system of this invention is to provide a “Garbage Lock” that holds the Garbage Can firmly in place to prevent spills, haphazard to public, improving hygiene as well as esthetics.

### BRIEF DESCRIPTION OF THE DRAWINGS

The following are the related drawings of the invention:

FIG. 1. Illustration of the invention disassembled

FIG. 2. Illustration of front, side and top views of the invention

FIG. 3. Illustration of the sequence of operation

Numeric reference in the drawings:
a) 10 COVER
b) 12 FRONT HANDLE
c) 14 CAN
d) 16 BASKET FRAME
e) 18 SIDE HANDLE
f) 20 WHEELS
g) 22 66 LB LIFT POWER MAGNET ASSEMBLY (Point a in the background of the Invention above)
h) 24 GALVANIZED SCREWS
i) 26 ANCHOR BOLTS
j) 28 CAST IRON BASE (Point b in the background of the Invention above

### DETAILED DESCRIPTION OF THE INVENTION

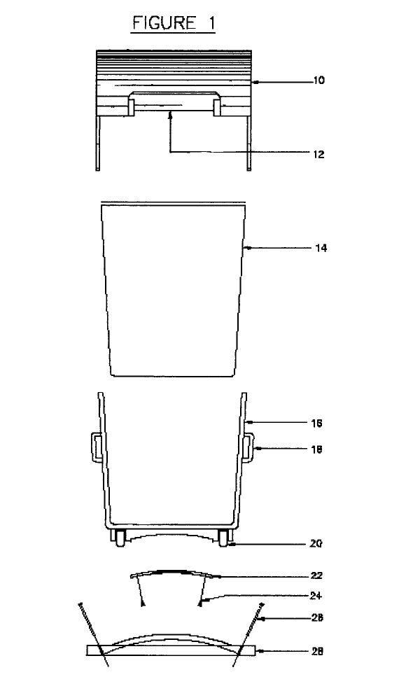

FIG. 1. Depicts the “Garbage Lock” disassembled. It also illustrates “22 66 LB LIFT POWER MAGNET ASSEMBLY” attached to the Garbage Can to pair with a “28 CAST IRON BASE” and the optional “26 ANCHOR BOLTS”.

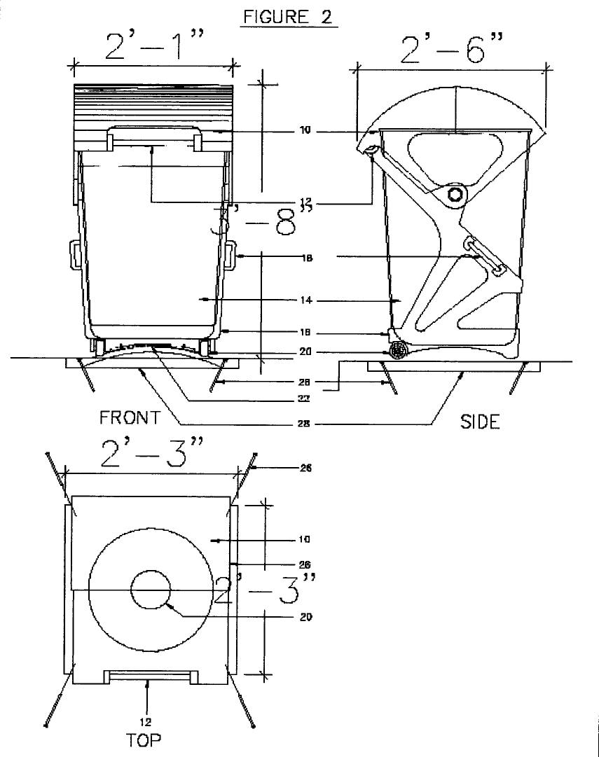

FIG. 2. Illustrates the “Garbage Lock” front, side and top views. It also depicts components: 10 COVER, 12 FRONT HANDLE, 14 CAN, 16 BASKET FRAME, 18 SIDE HANDLE, 20 WHEELS, 22 66 LB LIFT POWER MAGNET ASSEMBLY, 24 GALVANIZED SCREWS, 26 ANCHOR BOLTS, and 28 CAST IRON BASE.

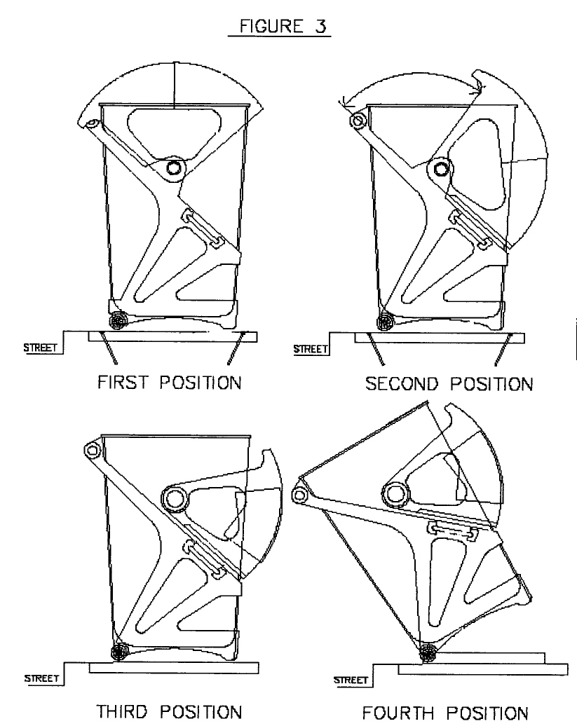

FIG. 3. Displays the “Garbage Lock” sequence of operation:
First Position: Idle covered
Second Position: Idle partial uncovered
Third Position: Idle full uncovered
Forth Position: Pull front handle to release magnetic attachment

Having described our invention, we claim:

1. This invention consists of:
a. A magnet attached to any Garbage Can
b. An iron base
This duo holds the Garbage Can firmly in place, while providing an easy way to empty its content.

2. The “Garbage Lock” features an easy way to empty the Garbage Can content by pulling the front handle to release the can with the magnetic attachment from the metallic base.
